(19) United States
(12) Patent Application Publication
(10) Pub. No.: US 2014/0198185 A1
(43) Pub. Date: Jul. 17, 2014

(54) MULTI-CAMERA SENSOR FOR THREE-DIMENSIONAL IMAGING OF A CIRCUIT BOARD

(71) Applicant: CyberOptics Corporation, Golden Valley, MN (US)

(72) Inventors: Paul R. Haugen, Bloomington, MN (US); Eric P. Rudd, Hopkins, MN (US)

(73) Assignee: CyberOptics Corporation, Golden Valley, MN (US)

(21) Appl. No.: 14/154,838

(22) Filed: Jan. 14, 2014

Related U.S. Application Data
(60) Provisional application No. 61/753,496, filed on Jan. 17, 2013.
(60) Provisional application No. 61/765,399, filed on Feb. 15, 2013.

(51) Int. Cl. H04N 13/02; G06T 7/00

(52) U.S. Cl. CPC H04N 13/0282; G06T 7/0008
USPC 348/48; 348/47

(57) ABSTRACT

A system for sensing a three-dimensional topology of a circuit board is provided. An illumination source projects an illumination pattern from a first angle of incidence. A first camera acquires an image of the structured light pattern on the circuit board from a second angle of incidence. A second camera simultaneously acquires an image of the structured light pattern on the circuit board from a third angle of incidence, the third angle of incidence differing from the second angle of incidence. A controller is coupled to the illumination source and to the at least two camera devices. The controller generates a height topology of the circuit board based on images acquired from the at least two camera devices of the structure light illuminator.

### CROSS-REFERENCE TO RELATED APPLICATIONS

The present application is based on and claims the benefit of U.S. Provisional Patent Application Ser. No. 61/753,496, filed Jan. 17, 2013 and U.S. Provisional Patent Application Ser. No. 61/765,399, filed Feb. 15, 2013, the content of which applications is hereby incorporated by reference in their entireties.

### COPYRIGHT RESERVATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Circuit boards that carry electronic integrated circuits and discrete electronic components are well known. A circuit board substrate is prepared with predetermined conductor paths and pads for receiving the leads of electronic components such as integrated circuit chips, resistors or capacitors. During the circuit board assembly process, solder paste deposits are placed onto the board substrate at appropriate positions. The solder paste deposits are usually applied by placing a stencil screen onto the substrate, applying solder paste through the stencil openings and removing the stencil from the substrate. The circuit board electronic components are then positioned onto the substrate, preferably with a pick and place machine, with leads of the electronic components placed on the respective solder paste deposits. The circuit board is passed through an oven after all of the components are positioned on the substrate to melt the solder paste deposits thus creating an electrical as well as mechanical connection between the components and the substrate.

The size of the solder paste deposits and electronic components and the accuracy with which they must be placed on the substrate has become increasingly smaller and tighter with the increased emphasis on miniaturization in the electronics industry. Solder paste deposit heights can be as small as 50 microns and the height of the solder paste brick must often be measured to within 1 percent of the designed height and size. The center-to-center spacing between solder bricks is sometimes as little as 200 microns. Too little solder paste can result in no electrical connection between the lead of an electronic component and the pad of the circuit board substrate. Too much paste can result in bridging and short-circuiting between the leads of a component. Discrete electronic components such as resistors and capacitors can be as small as 200×400 microns and leads on micro ball grid array components can have a center-to-center spacing less than 300 microns.

A single circuit board can cost thousands and even tens of thousands of dollars to manufacture. Testing of a circuit board after the fabrication process is complete can detect errors in solder paste placement and component placement and lead connection, but often the only remedy for a faulty board is rejection of the entire board. In addition, with the miniaturization of components, visual inspection of the circuit board, even with optical magnification, is unreliable. It is accordingly imperative that a circuit board be inspected during the fabrication process so that improper solder paste deposits can be detected prior to the placement of the electronic components onto the substrate. Such in-process solder inspection reduces the cost of failure since expensive components have not yet been placed onto the circuit board.

After placement, it is also important to inspect the components to ensure proper placement of the components. Improperly placed components, missing components or poor solder joints are typical defects introduced during the placement of the components and reflow of the solder paste. After reflow, proper placement of the components and the quality of the reflowed solder junctions can be inspected using an automated optical inspection system to ensure that all components are properly soldered and connected to the circuit board. Current optical inspection systems use 2D video images of the circuit board to detect defects. However, optical inspection systems that detect 3D height images of the circuit board make possible or otherwise improve the detection of placement defects such as lifted leads, package coplanarity, and component tombstones and billboards.

The use of white light phased profilometry is a well-known technique for optically acquiring topological surface height images of circuit boards. However, current circuit board inspection sensors that employ phased profilometry have some limitations. Typical phase profilometers used to acquire topological surface height images of circuit boards generally use triangulation principles combined with structured light to determine the height of the surface at every pixel defined by the sensor's camera. One limitation of using triangulation sensing to produce a height image of a circuit board is that the incident angle of the pattern projection optical axis and image sensing optical axis are different. If the circuit board has height features that have an edge slope large enough that they occlude either the pattern projection optical axis or image sensing optical axis relative to some area on the surface, the sensor will not be able to measure those areas of the circuit board.

Referring to the diagram of the height image sensor in FIG. 1, one approach to mitigate the triangulation shadow effect is to use multiple pattern projection sources with a normally incident camera. Each of the sources projects a structured pattern onto the circuit board from different incident angles. If one pattern projection source is occluded, or otherwise blocked, from an area of the test surface, there is a high probability that the other pattern projection source will be able to illuminate that area. To acquire a non-occluded height image, the camera acquires images from each of the pattern projection sources serially and then combines the results of the multiple height images to ensure all areas of the image contain valid height data. Typically, the height image sensor is held stationary while acquiring multiple images from each of the sources. One disadvantage to this approach is that it requires multiple image acquisition cycles of one field of view (FOV) to generate a single height image which slows down the overall acquisition process when compared to a sensor that uses a single source. Implementation of multiple source white light phase triangulation sensors requires the pattern projection sources to be turned on separately so that the image from one source, followed by acquisition of an image from another source, can be acquired in sequence by the camera. This operation will typically require two or more image acquisition cycles of the sensor in order to acquire height image data.

In the sensor shown in FIG. 1, the structured light is characteristically generated by imaging a reticle consisting of a fixed chrome-on-glass pattern onto the circuit board. To acquire a height image, a sequence of patterned images are required, each of the images being a shifted version of the previous image. Typically, the structured pattern is a sinusoidal intensity pattern and the sequence of images are the same sinusoidal pattern; each image of the sequence shifted relative to the other images of the sequence some known fraction of the sinusoidal period. Usually, the phase shift in the sequence of images is created by physically moving the reticle within the sensor. One disadvantage to utilizing a chrome-on-glass reticle is that changing the frequency or orientation of the structured light requires replacing the reticle, changing the magnification of the pattern projection optics or both. Additionally, physically moving a glass reticle within the sensor requires expensive mechanical motion components.

Providing a multiple viewpoint triangulation sensor for generating height images of a circuit board using phased structured light that does not have the associated cost or speed penalty that is present in the current state of the art for multiple source phase height image sensors would represent a useful advance to high-speed three-dimensional inspection of circuit boards.

Additionally, coupled with the multiple viewpoint triangulation sensor, providing a way to change the frequency, orientation and type of the structured light pattern in real time without physically moving the reticle would allow the sensor to change characteristics without modifying the sensor hardware and would increase the reliability of the sensor.

### SUMMARY

A system for sensing a three-dimensional topology of a circuit board is provided. An illumination source projects an illumination pattern from a first angle of incidence. A first camera acquires an image of the structured light pattern on the circuit board from a second angle of incidence. A second camera simultaneously acquires an image of the structured light pattern on the circuit board from a third angle of incidence, the third angle of incidence differing from the second angle of incidence. A controller is coupled to the illumination source and to the at least two camera devices. The controller generates a height topology of the circuit board based on images acquired from the at least two camera devices of the structure light illuminator.

### BRIEF DESCRIPTION OF THE DRAWINGS

FIG. 1 is a diagrammatic view of a height image sensor used to inspect circuit boards in accordance with the prior art.

FIG. 2 is a diagrammatic image of a structured light phase pattern projection system that is typically used to illuminate the circuit board under test.

FIG. 3 is a diagrammatic view of a multi-camera height image sensor using phased structured light in accordance with an embodiment of the present invention.

FIG. 4 is a diagrammatic view of multi-camera height image sensor for three-dimensional imaging using phase structured light generated by a spatial light modulator (SLM) in accordance with an embodiment of the present invention

FIG. 5 is a diagrammatic view of a four-camera sensing system for a height image sensor using phase structured light generated by a spatial light modulator in accordance with an embodiment of the present invention.

FIG. 6 is flow diagram of a method of acquiring images and generating height maps in accordance with an embodiment of the present invention.

FIG. 7 is a diagrammatic view of a four-camera sensing system for a height image sensor using phase structured light generated by a spatial light modulator where one pair of cameras provides black and white images and a second pair of cameras provides color images in accordance with an embodiment of the present invention

FIG. 8 is a diagrammatic view of a four-camera sensing system for a height image sensor using phase structured light generated by a spatial light modulator where each pair of cameras is configured with a different optical magnification in accordance with an embodiment of the present invention

FIG. 9 is a diagrammatic view of a four-camera sensing system for a height image sensor using phase structured light generated by a spatial light modulator where each pair of cameras provides a separate triangulation angle in accordance with an embodiment of the present invention.

### DETAILED DESCRIPTION OF ILLUSTRATIVE EMBODIMENTS

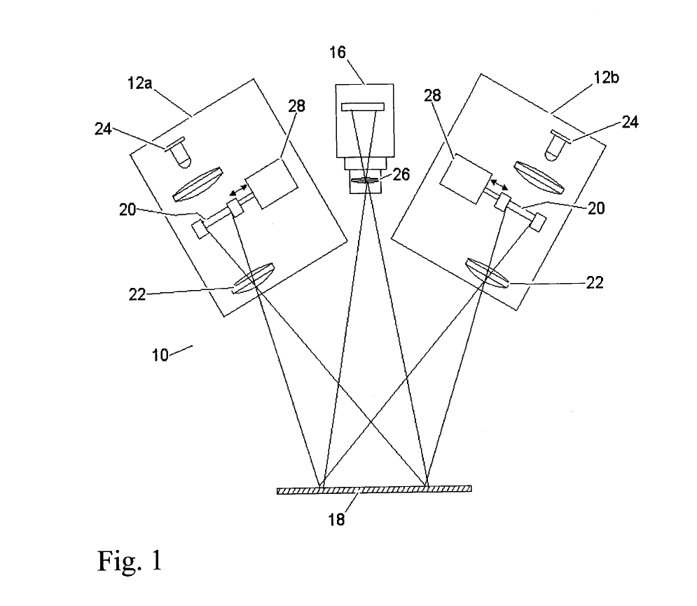

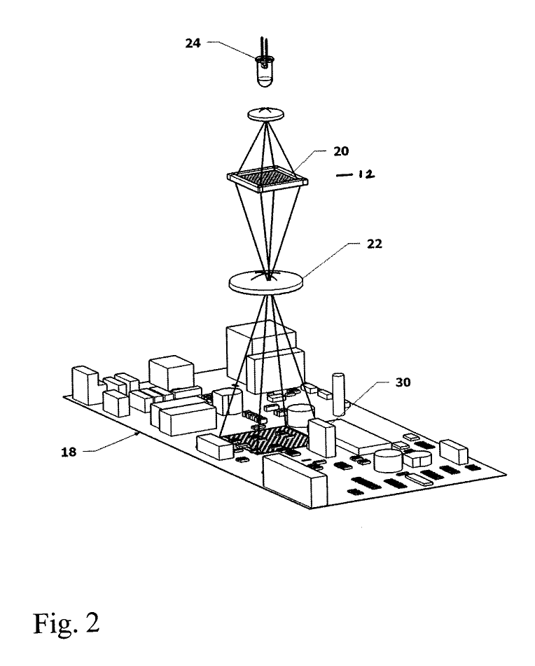

FIG. 1 is a diagrammatic view of a height image sensor in accordance with the prior art. FIG. 1 represents a system upon which improvements in accordance with embodiments of the present invention can be easily compared. FIG. 1 shows a multiple projection source height image sensor 10, which includes a first pattern projection source 12a, a second pattern projection light source 12b and an image sensing camera 16. Each of the pattern projection light sources 12a, 12b project a structured light pattern onto a circuit board 18 by imaging a chrome-on-glass reticle 20 using an imaging lens 22. The reticle is backlit using a bright light source 24 such as a white light LED. FIG. 2 shows the configuration of the pattern projection light source 12 and the resulting projected sinusoidal intensity pattern 30. The image sensing camera 16 can employ any one of several image sensing technologies used in machine vision such as CCD or CMOS detectors coupled with an imaging lens 26 that images circuit board 18 onto the detector. The difference between the optical axis incidence angles of optical image sensor 16 and each of two pattern projection sources 12a, 12b is the triangulation angle of height sensor 10.

In the system described with respect to FIG. 1, pattern projection sources 12a and 12b each project the image of reticle 20 onto circuit board 18. Reticle 20 contains an intensity mask that when projected by imaging lens 22, produces a sinusoidal structured light pattern 30 shown in FIG. 2 on circuit board 18. The image of sinusoidal structured light pattern 30 is acquired by camera 16. Variations, or phase differences, in sinusoidal structured light pattern 30 are used to determine the height of circuit board 18 at each point in the height image.

In operation, structured light source 12a projects a sinusoidal structured light pattern 30 onto the circuit board 18 and an image is acquired by camera 16. Reticle 20 is then shifted an equivalent distance of a fractional phase distance of the sinusoidal pattern by a linear actuator 28 and camera 16 acquires a second image. A similar sequence of image acquisitions and reticle shifts then occurs to collect images generated from structured light source 12b by camera 16. In all, the number of images required to generate a height image by multiple projection source height image sensor 10 is n×m where n is the number of structured light sources and m is the required number of phase images. Since the number of phase images required for a reliable height image is typically three or four, the number of the images captured by the camera 16 per generated height image is six to eight. To improve measurement performance, it is also typical to increase the number of pattern projection sources 12 to four which increases the required number of images to twelve to sixteen images acquired per height image by camera 16. Because the multiple projection source height image sensor 10 shown in FIG. 1. employs a single camera 16, the images are acquired in a time serial mode. It is easily seen, that with serial acquisition, the time to acquire images from multiple sources increases the amount of time the sensor requires to acquire a single height image with each additional source.

The method of converting the intensity information from the multiple sinusoidal intensity pattern images to actual height images can be in accordance with any known techniques, such as those described in U.S. Pat. No. 6,750,899.

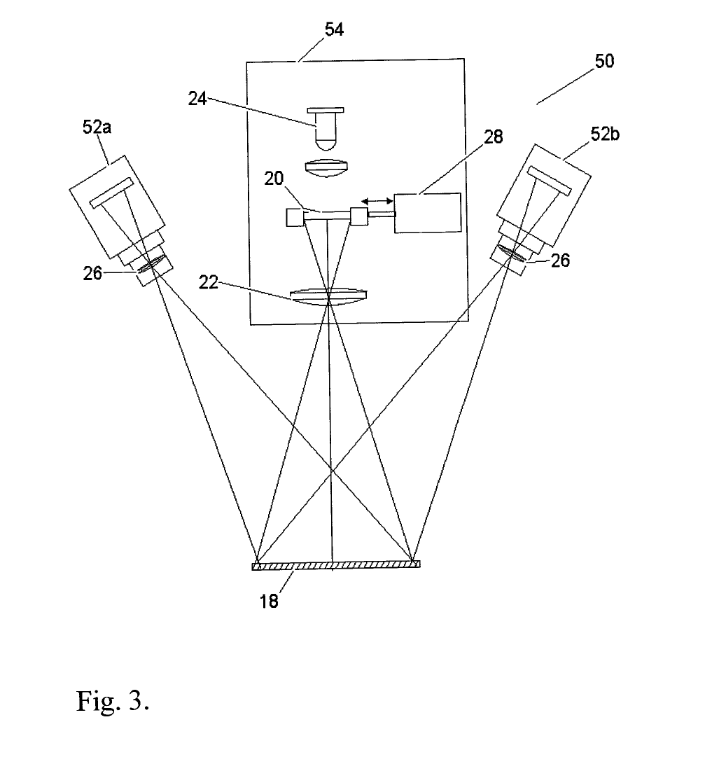

FIG. 3 is a diagrammatic view of a multiple imaging device height image sensor 50 for three-dimensional imaging of a circuit board using phased structured light in accordance with an embodiment of the present invention. A pattern projection source 54 projects sinusoidal structured light pattern 30 onto circuit board 18 by imaging chrome-on-glass reticle 20 with imaging lens 22. The reticle is backlit using bright light source 24 such as a white light LED. Two image sensing cameras 52a, 52b are configured to simultaneously acquire images of circuit board 18 illuminated with sinusoidal structured light pattern 30 projected by pattern projection source 54. Cameras 52a, 52b can be any one of several image sensing technologies used in machine vision such as CCD or CMOS detectors coupled with imaging lens 26 that images the circuit board unto the detector. The difference between the optical axis incidence angles of pattern projection source 54 and the cameras 52a, 52b represents the triangulation angle of the height sensor.

In operation, light source 24 backlights reticle 20. Imaging lens 22 projects the reticle onto circuit board 18. Simultaneously, cameras 52a, 52b acquire images of the circuit board 18 during the illumination period. Reticle 20 is then shifted an equivalent distance of a fractional phase distance of the sinusoidal pattern by linear actuator 28 and the cameras 52a, 52b acquire a second image. Since cameras 52a, 52b acquire images of the projected structured light pattern 30, only one image acquisition time is required to generate height images from two different triangulation angles.

In all, the number of images required to be acquired by multiple camera height image sensor 50 is n×m where n is the number of image sensors 52 and m is the number of phase images. However, the number of patterns that are projected is only m. Since the number of phase images required for a reliable height image is typically three, the number of images acquired by each of cameras 52a, 52b remains constant at three. To improve performance, it is possible to increase the number of cameras to four which increases the number of images per capture to twelve. However, since the four cameras are acquiring images in parallel, the time to acquire all twelve images is only the time required to project and image three images. With parallel acquisition, the time required to acquire a single height image is the same for a height image sensor comprised of a single camera as a sensor comprised of multiple cameras. Since adding multiple cameras greatly improves the quality of the height image without increase time of generating the height image, this embodiment of the invention is a major advantage over prior art techniques, reducing the overall time to inspect circuit board 18.

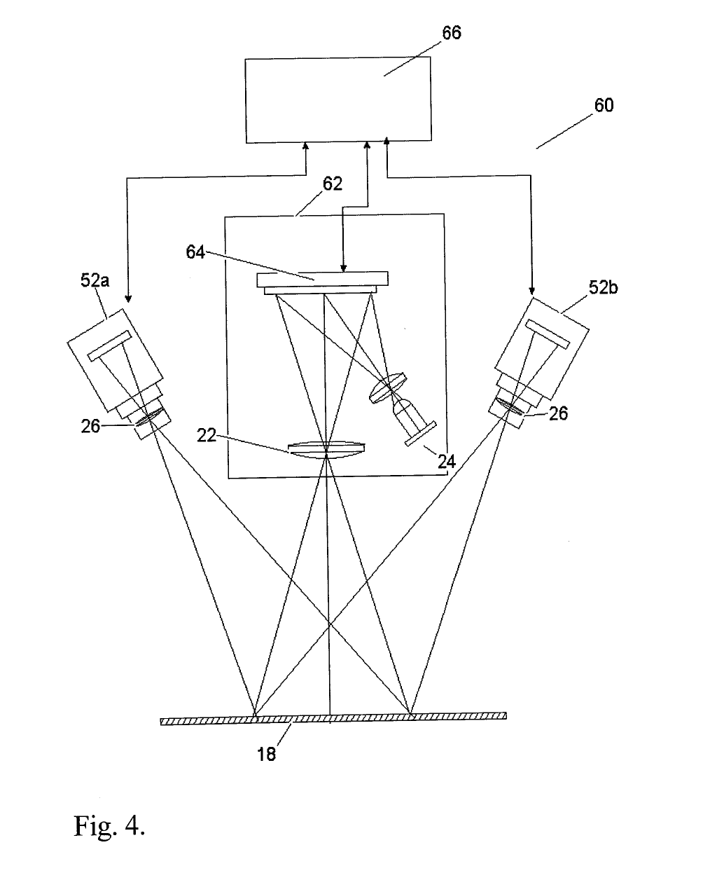

FIG. 4 is a diagrammatic view of a multiple imaging device height image sensor 60 for three-dimensional imaging of circuit board 18 using phased structured light in accordance with another embodiment of the present invention. A pattern projection source 62 is coupled to controller 66 and projects structured light pattern 30 onto circuit board 18 by imaging a spatial light modulator (SLM) 64 with imaging lens 22. In one embodiment, SLM 64 is a device available from Texas Instruments (e.g. TI part number DLP5500). This device incorporates an array of digital micro minors (DMDs) which are individually addressable to form an arbitrary image on the surface. In operation, the required structured light pattern 30 is programmed on the DMD array. The programmed image causes each of the micro minors to tilt to one of two positions which correspond to the pixel intensity value of the image at the individual mirror's location. For pixels that are high brightness, the tilted DMD reflects the light from light source 24, through imaging lens 22 to the circuit board 18 producing a bright pixel. For pixels that correspond to low brightness in the structured light pattern 30, the tilt of the DMD mirror reflects light from light source 24 away from the imaging lens 22 producing a dark pixel in structured light pattern 30. By changing the programmed image sent to the DMD, the required sequence of phase shifted images can be generated. SLM 64 is illuminated using bright light source 24 such as a white light LED. Two cameras 52a, 52b are coupled to controller 66 and are configured to simultaneously acquire an image of the circuit board 18 illuminated with structured light pattern 30. Cameras 52a, 52b can be any one of several image sensing technologies used in machine vision such as CCD or CMOS detectors coupled with imaging lens 26 that images the circuit board unto the detector. The difference between the optical axis incidence angles of pattern projection source 62 and the cameras 52a, 52b represents the triangulation angle of the height sensor.

In operation, light source 24 illuminates SLM 64 and pixels that are programmed with high brightness values reflect light through imaging lens 22. Imaging lens 22 projects the light from SLM 64 onto the circuit board 18. Simultaneously, both cameras 52a, 52b acquire a first image of the circuit board 18 during the illumination period. The projection pattern programmed into SLM 64 is then changed to a second sinusoidal pattern with a relative phase shift of an equivalent distance of a fractional phase distance of the first sinusoidal pattern and cameras 52a, 52b acquire a second image. Finally, the projection pattern programmed into SLM 64 is then changed to a third sinusoidal pattern with a relative phase shift of an equivalent distance of a fractional phase distance of the first and second sinusoidal patterns and cameras 52a, 52b acquire a third image.

Using SLM 64 to generate a sequence of structured light images has advantages over using a mechanically shifted chrome-on-glass reticle. With a chrome-on-glass reticle, structured light pattern 30 is fixed with the chrome-on-glass pattern and sequences of images with differing phases are generated by physically moving the reticle. Physically moving the reticle is costly and requires motion components that are prone to mechanical wear and ultimately failure. In addition, it is often required to change the sinusoidal pattern's period. By changing the sinusoidal pattern's period, the height range and height resolution of the height image sensor can be adjusted. Changing the height range of the sensor is particularly important when inspecting a circuit board after components have been placed since the height of the placed components can be higher than the height range of the sensor which is determined by the reticle pattern. Changing the chrome-on-glass reticle pattern requires physically replacing one reticle with another which typically cannot be accomplished during operation of the sensor.

With SLM 64, various patterns can be projected unto circuit board 18 simply by programming an array of numbers into the controller 66. Projecting an image sequence with varying phases is simply accomplished by programming successive images to controller 66. By addressing the successive images from controller 66 memory, a sequence of phase images is projected without physically moving the reticle. In addition, by changing the phase period of the pattern programmed to controller 66, the height resolution and height range of height imaging sensor 62 can be changed during the operation of the sensor.

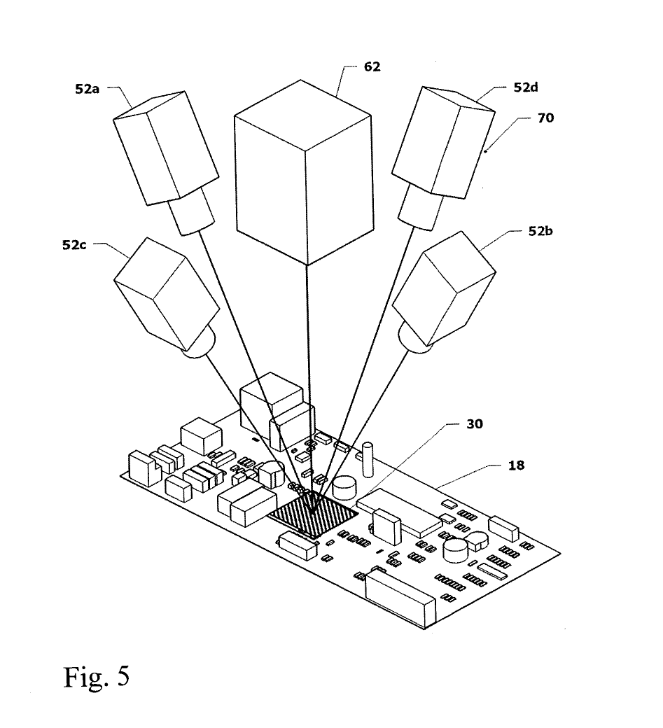

FIG. 5 is a diagrammatic view of a multiple imaging device height image sensor 70 for three-dimensional imaging of a circuit board using phased structured light in accordance with a third embodiment of the present invention. In this embodiment, four cameras 52a, 52b, 52c, 52d are configured to simultaneously acquire images of sinusoidal structured light pattern 30 on circuit board 18 from four distinct incident angles. Each of the four cameras' 52a, 52b, 52c, 52d incident angle form a triangulation angle relative to the projection incident angle of pattern projection source 62. Pattern projection source 62 projects sinusoidal structured light pattern 30 onto circuit board 18. Cameras 52a, 52b, 52c, 52d are preferably triggered simultaneously to acquire an image of the sinusoidal pattern 30. Structure light source 62 projects a second sinusoidal pattern with a relative phase shift of an equivalent distance of a fractional phase distance of the first sinusoidal pattern and the four cameras 52a, 52b, 52c, 52d are triggered simultaneously to acquire a second set of images. Finally, the projection pattern programmed into SLM 64 is then changed to a third sinusoidal pattern with a relative phase shift of an equivalent distance of a fractional phase distance of the first and second sinusoidal patterns and cameras 52a, 52b, 52c, 52d each acquire a third image.

The images acquired by cameras 52a, 52b, 52c, 52d are sent to a controller, not shown, which processes the images sets into a height image. Using four cameras improves the quality of the height map by decreasing imager noise effects and further eliminating the chance of an area of circuit board 18 to be in shadow or otherwise false height data. Since the images are acquired by cameras 52a, 52b, 52c, 52d simultaneously, there is no impact on multiple imaging device height image sensor's 70 acquisition speed.

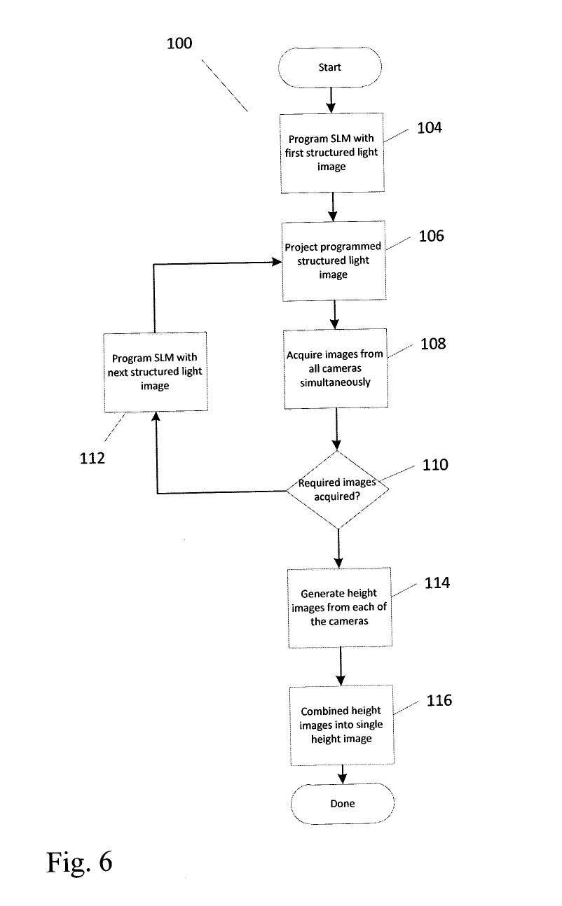

FIG. 6 shows a flow diagram that describes the process 100 used by controller 66 to acquire and process images from cameras 52a, 52b, 52c, 52d to generate a combined height image. In step 104, the first structured light pattern is programmed to SLM 64. In step 106, an image of the structured light pattern is projected onto the circuit board. The cameras are all triggered at the same time in step 108 to acquire images of the structured light pattern from four different viewpoints. If more structured light patterns are required for the height reconstruction, the next structured light pattern is programmed to the SLM in step 112. Steps 106, 108 and 112 are repeated until the required number of patterns have been projected and acquired. In step 114, the controller generates a height image from the images acquired from each of the cameras. Each of the height images generated from images acquired from cameras 52a, 52b, 52c, 52d are combined into a single height image in step 116. Since the combined height image combines the height images from multiple camera viewpoints, the resulting height image has higher fidelity.

In addition to generating height images using multiple cameras and structured light as described above, the functionality of all embodiments can be extended by using pairs of angled cameras present in these embodiments to generate an additional height image using stereo image pair. Producing height images based on a stereo pair cameras with different points of view is a well-known technique. Prior art height image sensor 10 shown in FIG. 1 employs only a single camera. Therefore, it is not possible to generate height images using stereo vision techniques. However, multiple imaging device height image sensors 50, 60, 70 all are configured with at least two cameras with different angles of incidence. In operation, a stereo pair of images can be acquired from any pair of cameras 52a, 52b, 52c, 52d and a height image can generated independent of the structured light source. The height image generated from the stereo vision technique then can be combined with height image generated using pattern projection source 62 to generate a height map with less noise and higher resolution.

In some embodiments, the performance of the height image sensor is further enhanced by configuring each or combinations of the multiple cameras with different operating characteristics. For one embodiment, at least one of the cameras is configured as black and white (B/W) monochrome camera and at least one of the cameras is configured as a color camera. Acquiring a color image of the circuit board is desired to enhance the user's visualization of the circuit board and to enhance 2D images that are used to recognize features on the circuit board. However, cameras that are typically used to acquire color images employ Bayer color filters over the semiconductor detector array, which when combined into a color image, effectively reduces the spatial resolution of the camera. Using and combining the images generated from each of the B/W camera and color camera, a high resolution height map can be generated with images from the B/W cameras and a lower resolution height image and color image of the circuit board can be generated with images from the color cameras. By combining these height images, high performance height image and a color image of the circuit board is generated during one height image acquisition cycle.

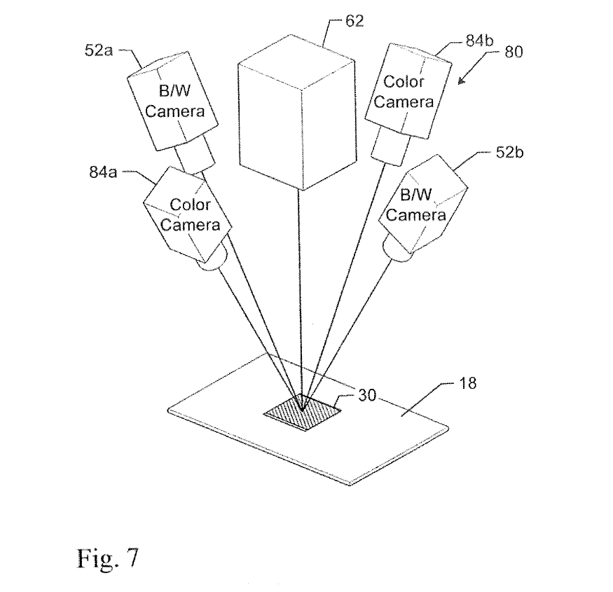

FIG. 7 is a diagrammatic view of a multi-camera sensor for three-dimensional imaging of a circuit board in accordance with an embodiment of the present invention. Height image sensor 80 acquires height images using the process described in FIG. 6. In this embodiment, one pair of cameras 52a, 52b is configured to acquire black and white (B/W) images and the second pair of cameras 84a, 84b is configured to acquire color images of structured light pattern 30. Color image sensing based on Bayer pattern filters produce color images; however, the spatial resolution of the image is reduced due to the encoding of the color which decreases the effective spatial resolution of the camera and the resulting height image. In operation, the color information from color cameras 84a, 84b can be used in combination with the height image data generated by all four cameras 52a, 52b, 84a, 84b to display a color topological map. By combining a pair of B/W cameras 52a, 52b, and a pair of color cameras 84a, 84b, the spatial resolution of the resulting height map is maintained while the visualization advantages derived from the height and video images acquired by the pair of color cameras 84a, 84b is realized.

In another embodiment, each of the cameras of the height image sensor is configured to use a different exposure time. Using multiple exposure times is a technique used in some machine vision applications to improve the dynamic range of a single camera. However, for a single camera, images based on multiple exposure times requires multiple image acquisition cycles which increases the total time required to acquire the image. Using multiple cameras, each using a different exposure time, the resulting height and video images have increased dynamic range without incurring a time penalty.

The height sensor 70 in FIG. 5 is configured such that the first pair of cameras 52a, 52b is configured with a short exposure time and the second pair of cameras 52c, 52d is configured with a long exposure time. By configuring images sensing devices 52a, 52b with a short exposure time, reflective areas of circuit board 18 will generate quality height images while dark areas of circuit board 18 will have poor quality images. By configuring cameras 52c, 52d with a long exposure time, dark areas of circuit board 18 will have proper exposure time and the resulting height images will be of high quality in these dark areas. By combining the height map of the first pair of cameras 52a, 52b with the height image from the second pair of cameras 84a, 84b, the overall dynamic range of the height image sensor 70 is improved. With this embodiment, the height image sensor 70 can generate height images of larger dynamic range which is required to generate height images of circuit boards that may contain dark areas of solder mask and shiny areas of reflowed solder.

In another embodiment, at least one of the cameras is configured with a large field of view and at least one of the cameras is configured with higher magnification optics creating a higher resolution image. For measurements that require high performance, the height images generated by the high magnification cameras can be used. For areas of the circuit board that do not require high resolution height maps and in applications where high speed is required, the cameras that are configured with a larger FOV are used. In practice, switching between the high resolution cameras and the large field of view cameras is equivalent to adding zoom functionality to the height sensor without using moving optical components found in typical optical zoom systems. In addition, both high resolution and large FOV images are acquired at the same time.

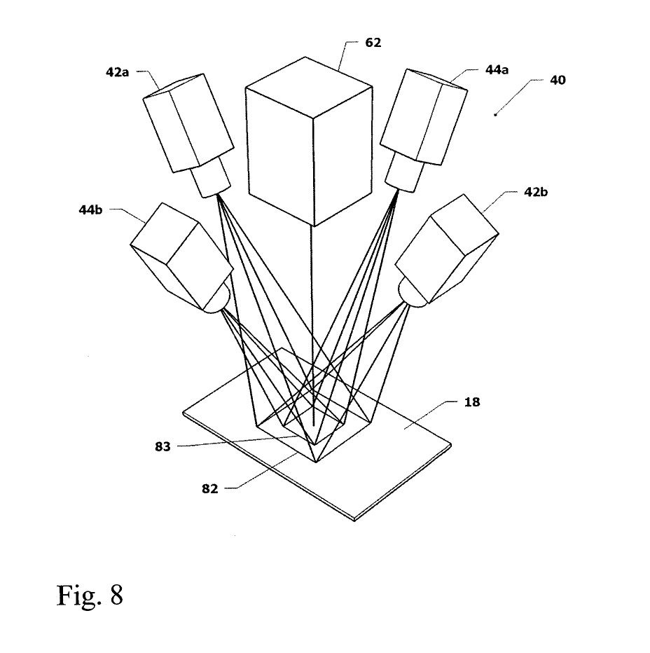

FIG. 8 is a diagrammatic view of a multiple camera height image sensor 40 for three-dimensional imaging of a circuit board using phased structured light in accordance with another embodiment of the present invention. In FIG. 8, the first pair of cameras 42a, 42b is configured with a relatively large field of view (FOV) and the second pair of cameras 44a, 44b is configured with a relatively small FOV. By configuring cameras 42a, 42b with a large FOV, a height image from a larger area of circuit board 18 is acquired. Using a larger FOV, the time to scan and acquire height images of the whole circuit board 18 is reduced. However, for a given camera pixel count, larger FOV's result in a larger image pixel size and therefore, lower height image lateral resolution. To improve the lateral resolution of the height image sensor 40, the second pair of cameras 44a, 44b is configured with higher optical magnification which produces a smaller FOV and proportionally higher lateral resolution. The height image generated from cameras 44a, 44b has high spatial resolution which will yield higher performance height measurements for small artifacts. In addition, the height image generated by the high resolution camera pair 44a, 44b can be combined with the height image generated by the camera pair 42a, 42b to further enhance the fidelity of the height image. Since images from the two pairs of cameras can be used separately or be combined selectively by the controller, a zoom function is realized by height image sensor 40 without the need for expensive mechanical means which are required to for typical optical zoom techniques.

In another embodiment, the triangulation angle between the structured light source and each of the cameras is varied. For a given structured light pattern, the range and resolution of the resulting height map is determined, in part, by the triangulation angle between the structured light source's optical axis and cameras' optical axis. By configuring each camera with a different triangulation angle, the combined height images will have a higher height resolution over a larger measurement range.

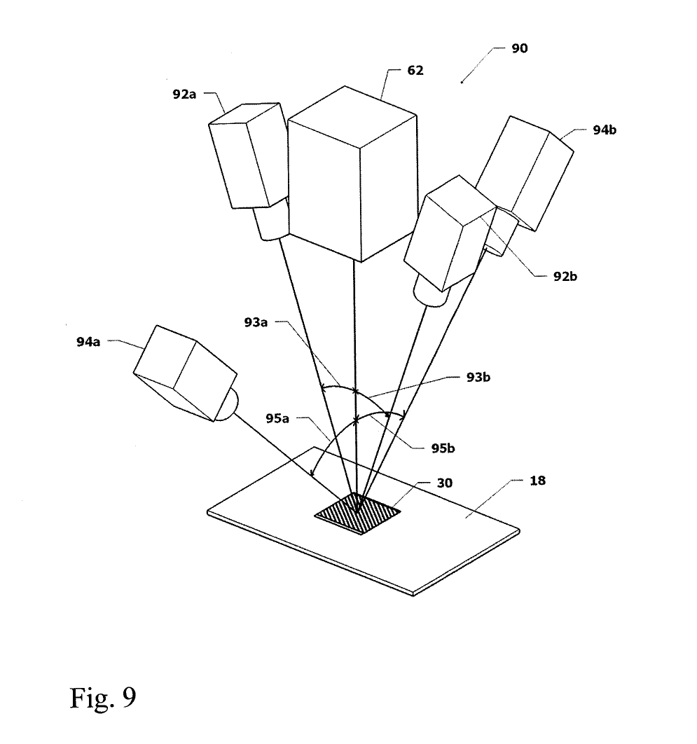

FIG. 9 is a diagrammatic view of a multiple imaging device height image sensor 90 for three-dimensional imaging of a circuit board using phased structured light in accordance with another embodiment of the present invention. In FIG. 9, first pair of cameras 92a, 92b is configured with small incident angles 93a, 93b and the second pair of cameras 94a, 94b is configured with large incident angles 95a, 95b. For a given spatial frequency of structured light pattern 30, the incidence angle of the cameras relative to the source 62 projection incidence angle determines the height measurement range and resolution of sensor 90. By configuring cameras 92a, 92b with small incidence angle 93a, 93b, the height image sensor 90 has a larger height measurement range and is capable measuring tall objects on circuit board 18. However, a larger height measurement range will decrease the height resolution of sensor 90 and generate lower measurement performance on small artifacts. To improve the performance of the height image sensor 90 on small artifact measurements, the second pair of cameras 94a, 94b is configured with large incidence angles 95a, 95b. Larger incident angles produce higher resolution height measurements but decreases the height range of the sensor. By combining the height images generated by the first image camera pair 92a, 92b and the second camera pair 94a, 94b, high resolution height images can be generated over an extended height range.

In each embodiment, a controller is coupled to the illumination source and to the cameras. The controller preferably generates a height topology of the circuit board based on images of the structured light acquired from the cameras. The controller can be configured to program the structured light source to project a light pattern onto a target, acquire images of the projected light pattern from the each of the cameras, generate a height image and a video image from images acquired from each of the cameras, and combine separated height and video images into composite height and video images.

Although the present invention has been described with reference to preferred embodiments, workers skilled in the art will recognize that changes may be made in form and detail without departing from the spirit and scope of the invention. For example, while embodiments of the present invention generally describe the utilization of a CMOS detector, any suitable image acquisition device including a CCD array can be used. Also, while embodiments of the present invention generally describe the utilization of DVM device, other SLM technologies, such as Liquid Crystal Display Devices (LCD) and Liquid Crystal on Silicon (LCOS) SLM can also be used to produce programmable structured light patterns. In the present invention, these programmable structured light patterns were described as sinusoidal intensity patterns. However, there are several other suitable patterns such as binary gray code patterns and pseudo random structured patterns.

What is claimed is:

1. A system for sensing a three-dimensional topology of a circuit board, the system comprising:
an illumination source configured to project a patterned illumination on the circuit board from a first angle of incidence;
a first camera configured to acquire an image of the pattern illumination from a second angle of incidence;
a second camera configured to acquire an image of the pattern illumination from a third angle of incidence; and
a controller coupled to the illumination source and to the first and second cameras, the controller being configured to generate a height image of the circuit board based on images acquired of projected pattern illumination on the circuit board with the first and second cameras.

2. The system of claim 1 wherein images acquired by the first and second cameras are combined to produce a single height image.

3. The system of claim 1, wherein the circuit board is populated with solder paste deposits

4. The system of claim 1, wherein the circuit board is populated with electrical components

5. The system of claim 1, wherein the illumination source includes a programmable spatial light modulator configured to generate multiple patterns in sequence

6. The spatial light modulator of claim 5, wherein the spatial light modulator projects patterns of varying spatial frequency.

7. A method of three-dimensionally mapping an image of a circuit board, the method comprising:
projecting a pattern image onto the circuit board from a first incident angle;
simultaneously capturing a first plurality of fringe phase images of the circuit board from a second incident angle and a third incidence angle;
simultaneously capturing a second plurality of fringe phase images of the circuit board from the second incidence angle and the third incident angle;
simultaneously capturing a third plurality of fringe phase images of the circuit board from the second incidence angle and the third incidence angle;
wherein the first, second and third pluralities of fringe phase images are captured while patterned illumination is disposed on the circuit board; and
computing a height map based on the first, second, and third plurality of fringe phase images.

8. The method of claim 7, wherein at least one of the first, second and third pluralities of fringe phase images are also used for stereoscopic height analysis.

9. The method of claim 7, wherein the pattern image is varied between acquisition of the first and second pluralities of fringe phase images.

10. The method of claim 9, wherein the pattern image is varied between acquisition of the second and third pluralities of fringe phase images.

11. The method of claim 9, wherein the pattern image is varied using a spatial light modulator.

12. A system for generating a three-dimensional height image of a test target, the system comprising:
an illumination source configured to generate a patterned illumination on the test surface;
a first camera configured to acquire a first image of the patterned illumination from a first point of view;
a second camera configured to acquire a second image of the patterned illumination from a second point of view;
the first and second cameras having different configurations; and
a controller coupled to the illumination source and to the first and second cameras, the controller being configured to generate a height image of the test surface based on the first and second images acquired of said patterned illumination, the height image being enhanced by a combination of the different configurations of the first and second cameras.

13. The system of claim 12, wherein the test target is a circuit board with solder paste deposits.

14. The system of claim 12, wherein the test target is a circuit board populated with electrical components.

15. The system of claim 12, wherein the first camera is configured to acquired color images and the second camera is configured to acquire monochrome images.

16. The system of claim 12, wherein the first camera is configured with a short exposure time and the second camera is configured with relatively longer exposure time.

17. The system of claim 12, wherein the first camera is configured with a larger optical magnification than the second camera.

18. The system of claim 12, wherein the first camera is configured with an incident angle and the second camera is configured with a larger incident angle.

19. A system for generating a three-dimensional height image of a test target, the system comprising:
an illumination source configured to generate a patterned illumination on the test target;
a first pair of cameras configured to acquire a first image pair of the patterned illumination from a first point of view;
a second pair of cameras configured to acquire a second image pair of the patterned illumination from a second point of view;
the first and second pairs of cameras having different configurations; and
a controller coupled to the source and to the first and second pairs of cameras, the controller being configured to generate a height image of the test target based on first and second image pairs acquired of said patterned illumination, the height image being enhanced by a combination of the different configurations of the first and second image pairs.

20. The system of claim 19, wherein the first pair of cameras is configured to acquire color images and the second pair of cameras is configured to acquire monochrome images.

21. The system of claim 19, wherein the first pair of cameras is configured with a short exposure time and the second pair of cameras is configured with relatively longer exposure time.

22. The system of claim 19, wherein the first pair of cameras is configured with a larger optical magnification than the second pair of cameras.

23. The system of claim 19, wherein the first pair of cameras is configured with first incident angles and the second pair of cameras are configured with second incident angles larger than the first incident angles.

25. A method of three-dimensionally mapping an image of a test surface, the method comprising:
projecting a plurality of illumination patterns onto the test surface from a first point of view;
capturing a first plurality of images of the test surface from a second point of view with a first camera configuration while the illumination patterns are disposed upon the test surface;
capturing a second plurality of images of the test surface from a third point of view with a second camera configuration while illumination patterns are disposed upon the test surface;
computing a height map of the test surface using the first and second plurality of illumination patterns images captured by the first and second camera configurations.

26. The method of claim 25, wherein the camera configurations are designed to improve the resolution of the resulting height image generated from the combined first and second plurality of illumination patterns images.
